(19) United States
(12) Patent Application Publication
(10) Pub. No.: US 2014/0372375 A1
(43) Pub. Date: Dec. 18, 2014

(54) CONTACT DATA SHARING

(71) Applicants: Mrinal Desai, Los Gatos, CA (US); Jorge Ferreira, Sammamish, WA (US)

(72) Inventors: Mrinal Desai, Los Gatos, CA (US); Jorge Ferreira, Sammamish, WA (US)

(21) Appl. No.: 13/917,564

(22) Filed: Jun. 13, 2013

(51) Int. Cl. G06F 17/30

(52) U.S. Cl. CPC G06F 17/30581
USPC 707/617; 707/624

(57) ABSTRACT

Contact data sharing is disclosed. Contact data sharing as disclosed provides various approaches to update contact data in devices that are remote to the person referred to in the contact date. In this way, contact data can be updated on remote devices when a person updates their own contact data. Contact data sharing allows a person to update their contact data, and then remote devices that list that person as a contact can automatically update the contact data without the user of the remote device having to enter it.

### BACKGROUND

1. Field of the Invention

The present invention relates generally to management of personal information, and more specifically to a system and method for contact data to be automatically updated across devices when it is changed on a single device.

2. Prior Art

A current contact data management approach allows a user to enter and store various types of contact information for multiple contacts. For example, a user of a smart phone may have an electronic address book application that is configured to store a phone number, an email address, a web address, a mailing address or other information related to people in an application that provides simple retrieval or use of the contact information.

Users often have multiple devices and therefore need to synchronize address books across their devices. Currently there are approaches for updating contact information for multiple devices operated by a single user. U.S. Patent Application Publication 2006/0242210, entitled CONTACT MANAGEMENT UPDATE PROTOCOLS, provides a system and method for synchronizing or merging folders managed by an owner or member. However, the approach in the subject publication generates a single folder that can then be used in multiple locations and therefore is restricted to folders managed by a single user.

### SUMMARY

Contact data sharing is disclosed. One embodiment provides a method for running a contact data sharing application on a device having access to an associated stored list of contacts, accessing user contact information for the device, sending the user contact information for the device to a remote device running a remote contact data sharing application, and in response to changing at least a portion of the user contact information on the device, sending at least a portion of the user contact information to the remote device using at least one of the contact data sharing application and the remote contact data sharing application for the remote device to update the user contact information. In this manner, when a person updates their own contact data, the remote devices that list that person as a contact can automatically update the contact data without the user of the remote device having to enter it.

Another disclosed embodiment describes a system to share contact data, comprising a stored list of contacts containing contact information for a plurality of contacts, a connection module to store connections created between a contact in the list of contacts and data entered on one or more remote devices by the subject of the contact in the list of contacts, and an update application including a contact management module to confirm a user record is created and to create a connection between a contact in the list of contacts and data entered on a remote device by the subject of the contact in the list of contacts, the update application further including a contact synchronize module to update the contact information in the list of contacts for a change in the contact information resulting from the data entered on a remote device by the subject of the contact in the list of contacts.

In one disclosed embodiment, a system to share contact data comprises an update service to manage connections between a stored list of contacts containing contact information for a plurality of contacts stored on at least one remote device, a contacts data store to store properties of contacts that are uploaded from remote devices, and a connections data store to store connections created between a contacts in the contacts data store and data entered on one or more remote devices by the subject of the contact in the contacts data store, wherein in response to a change to properties of a contact stored in the contacts data store, the update service sends a notification of the change to one or more remote devices connected to the contact in the connections data store. Other embodiments are disclosed in the following detailed description.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example embodiment of a system for contact data sharing.

FIG. 2 shows a process flow depicting a flowchart of a first embodiment of a method for contact data sharing.

FIG. 3 shows a process flow depicting a flowchart of a second embodiment of a method for contact data sharing.

### DETAILED DESCRIPTION

The present disclosure describes example contact data sharing embodiments. Generally, these embodiments update contact data in devices that are remote to the person referred to in the contact date. That is, they provide a way to have contact data updated on the remote devices when a person updates their own contact data. In this way, when a person updates their contact data, then remote devices that list that person as a contact can automatically update the contact data without the user of the remote device having to enter it. Other embodiments related to this general concept are also described in the following detailed description.

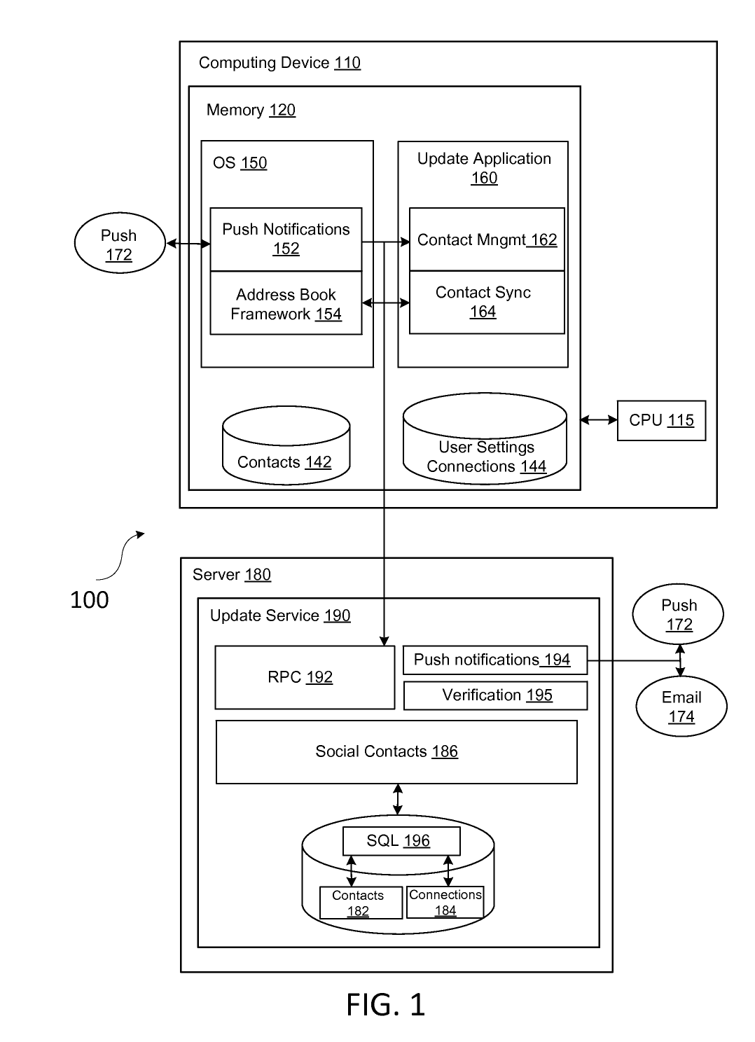

FIG. 1 shows an example embodiment of a system 100 for contact data sharing. System 100 includes a computing device 110 and a server 180. Other embodiments may utilize an update application and update service on different devices than those illustrated in FIG. 1 but still within the principles of this disclosure. For example a system may be distributed between end user devices such as mobile phones, may operate on a single device which sends updates out to connected remote devices, etc. In system 100, computing device 110 includes memory 120 to store an operating system (OS) 150 and an update application 160 and a CPU 115 to operate the operating system 150 and the update application 160. In some embodiments, CPU may be multiple processors or multiple cores of processors, single processors, distributed processors, etc.

Operating system 150 manages the computing device and also includes a module for push notifications 152 and an address book framework 154 which has access to a data store of contacts 142, such as an address book on a mobile phone or other communications or computing device. Contacts 142 may include any contact information, such as names, email addresses, phone numbers, employers, job titles, relationships, locations, physical addresses, and the like. This list of contacts may be accessed through the device's operating system 150 and utilized by multiple applications. For example, the operating system 150 may have imported the list of contacts from a SIM card and may synchronize the data on contacts list database with other services, like iCloud, Google, or Hotmail accounts, according to user settings. A user typically manages these contacts through an application pre-installed on a device.

In this example, push notification module 152 is connected to push notification service 172, but in other embodiments other update services may be used. Further, push notification module 152 may receive push notifications from a push notification service or remote server or device. In one example, a push notification may include a notification of a change to the contact information in a contact in the list of stored contacts.

In one embodiment, push notifications are sent when a new connection is created. For example, a user may add a contact in their contact list using a second user's name and email address. In this way, the service 190 can match the email address with the second user's name and create a one-way connection between the contact list entry and the second user who the contact information identifies. A push notification may then be sent to the second user.

In the illustrated embodiment, the notification can be a pending connection notification if there is only a one-way connection if the second user does not have the first user in their own contact list, or can be a full connection notification if there is a two-way connection and both the first and second user have each other in their contact list. In the instance of a one-way connection, once the second user receives the push notification the update application 160 can sync for a two-way connection or can display a pending connections view for a new pending connection.

In some embodiments, push notifications may be used for updates based on a user changing information other than contact information. For example, if a user updates a picture used to identify them through the service or another service, the update service 190 can receive a call to update the updated data and send a push notification to users that are connected to the user updating their picture or other data. In some embodiments, push notifications can be used to alert a user of any notification related to the service, other users, an action for them to complete, a user created message, etc.

Update application 160 includes a contact management module 162, a contact synchronization module 164 and update application 160 is coupled with a data store for user settings connections 144. The operating system 150 and update application 160 may be in communication with an update service 190. For example, in the illustrated embodiment update service 190 is running on a remote server 180.

In one example embodiment, contacts from computing device 110 may be matched to the contact data of other users by comparing properties. If they match, a one way connection can be created between a user and the contact and the connections are reported to the device. If the contact is connected back to the user, for example the contact have the user in their contact list, computing device 110 can request updates to contact data since a last synchronization and merge that data with a local copy of contact data. Additionally in this example, when new connections are created, a push notification can be sent to the device of the contact connected to.

In some embodiments, when a user is added to the system, the update service 190 may use an outside service to send an email to verify the email address. For example, when a user of an update application or update service creates a new account, an email with a code or a link to the new user. By clicking on the link and/or entering the code, the user can sign into the application or service. An email used in this manner could also be used as verification of the identity of the new user. In some embodiments an email may be used to notify users of new connections or updates to the service or application or in a similar manner as push notifications that are disclosed herein.

Referring back to the embodiment illustrated in FIG. 1, computing device 110 may be a system to share contact data, comprising a stored list of contacts 142 containing contact information for a plurality of contacts and a connection module 144 to store connections created between a contact in the list of contacts and data entered on one or more remote devices by the subject of the contact in the list of contacts. In this way an update application 160 or update service 190 can store a relationship between a contact record in contacts 142 and a user of the update application 160 or service 190. Additionally, a change token may also be stored in relation to the contact record to determine if the record has been changed. If the record has been changed, then update application 160 can send the changed information to update service 190 and the change can be distributed to other users of the service that have that contact stored in a list of contacts.

Furthermore, update application 160 can confirm a user record is created and to create a connection between a contact in the list of contacts and data entered on a remote device by the subject of the contact in the list of contacts. In the illustrated embodiment, update application 160 may use contact management module 162 as an interface to view, edit and/or communicate with contacts in their stored list of contacts 142. Additionally, the update application 160 may use contact synchronize module 164 to update the contact information in the list of contacts for a change in the contact information resulting from the data entered on a remote device by the subject of the contact in the list of contacts. In some embodiments, update application 160 can make requests to add users to the service, update the device token used for push notifications, and view or ignore pending connections that are not yet established.

Computing device 110 may use a change token to keep track of if a contact record in the list of contacts was changed or to use it to update contacts. For example, the change token may be sent to a remote update service such as update service 190 to determine if there has been any change in the contact information for a contact, and if there has been any change the system will receive the changed data and store a new change token representing the change. In some embodiments, the change token may include at least one of the last modified time of a contact in the list of contacts or a checksum string to identify the contact data from a user. Generally, a change token can be a generated unique identifier, such as a randomly generated unique identifier, as an example. In another example, a change token could be an incrementing number or a time stamp in combination with a new number. Other change tokens may be used that allow the update application to either determine the state of a contact record or to update contacts or information associated with contacts.

For example, computing device 110 may upload to a remote update service 190 a list of matching property data from each contact record in the stored list of contacts, wherein the contact management module 162 receives from the service a list of contacts that established a connection between a contact in the list of contacts and data entered on a remote device by the subject of the contact in the list of contact. Examples of property data include an email address or a phone number for a contact listed in the stored list of contacts, however other property data may be used.

Update service 190 also includes a remote procedure call module 192, a push notifications module 194 to send the change or a notification of the change to one or more remote devices connected to the contact in the connections data store, a verification module 195 to verify a person attempting to change their contact information is the person the contact information refers to, a social contacts module 186 that operates as a middle layer to assist in converting remote procedure calls to SQL 196 stored procedures and to receive SQL 196 results and call the push notification 194 and verification 195 services to return results back to a device, and a contacts 182 data store and a connections 184 data store. Additionally, in this embodiment contacts 182 and connections 184 are accessed by a structured query language module 196. As an example, a system such as update service 190 may manage connections between a stored list of contacts 182 containing contact information for a plurality of contacts records stored on multiple remote devices. In this example, the list of contacts 182 may store each user's contact record in the list of contacts 182, however other embodiments may store different contact or identifying data to be used to create and manage connections. In this embodiment, update service 190 utilizes a contacts data store 182 to store properties of contacts that are uploaded from one or more remote devices and a connections data store 184 to store connections created between a contact in the contacts data store.

In one example, a connection can be stored if a first user has a contact matching a second user. Another connection can be stored if the second user has a contact matching the first user. Embodiments may send updated contact information entered by a user to other users who have a connection with the first user, or to other users that have a connection to the first user when the first user has a connection to the second user, etc. Using the stored contacts and connections, the update service sends the change to one or more remote devices connected to the contact in the connections data store in response to a change to properties of a contact stored in the contacts data store.

In some embodiments, the update service receives a change token from a remote device, such as computing device 110, for at least some of the contact data for the user of the device, wherein the change token is used to determine if there has been any change in the contact information for the contact, and if there has been any change the update service will send the changed data and send a new change token representing the change. For example, the change token may include at least one of the last modified time of a contact in the list of contacts or a checksum string to identify contact data from a user, but other change tokens may be used that allow the update application to either determine the state of a contact record or to update contacts or information associated with contacts.

In some embodiments, the update service 190 may receive a list of matching property data from each contact record in the stored list of contacts on a remote device, such as computing device 110, and can then establish a connection between a contact in the list of contacts and data entered on a remote device by the subject of the contact in the list of contacts. As an example, the property data may include at least one of an email address or a phone number for a contact listed in the stored list of contacts.

In some embodiments, a user may send a suggestion for two other people to form a connection that can later then be automatically updated. In some embodiments, the suggested connection could be in the form of a request sent to one or both other people to form a one-way or a two-way connection that once established allows automatically updating contact information between them as described with reference to other embodiments herein.

In some embodiments, a user may select a different level of confidentiality for their contact information. For example, a user may have a contact record including their name, a photo, a company name, their job title, one or more phone numbers, and a work address and email. The user may select to have their name, photo, job title and work email address or phone number openly public so people they are not connected with them can connect with them. User selected multiple levels of confidentiality of their contact record allows the user to select from a subset of their contact data to all or none of their contact data to be available for a connection at the request of another user of the service, allowing their publicly shared contact data to be automatically updated for connections the authorized in advance by making that data public.

In this example, the contact data includes properties of the contact uploaded from the client in the form of a vCard file, helper data, a change token to determine if changes were made and a device identifier to communicate back to the device through push notifications. Different stored procedures are used to add new users, match contacts, update data or add connections.

The embodiments in FIG. 1 illustrate example protocols, services and the like are for illustrative purposes and embodiments may use any suitable protocols, services and the like other than those illustrated in FIG. 1 or otherwise in this disclosure.

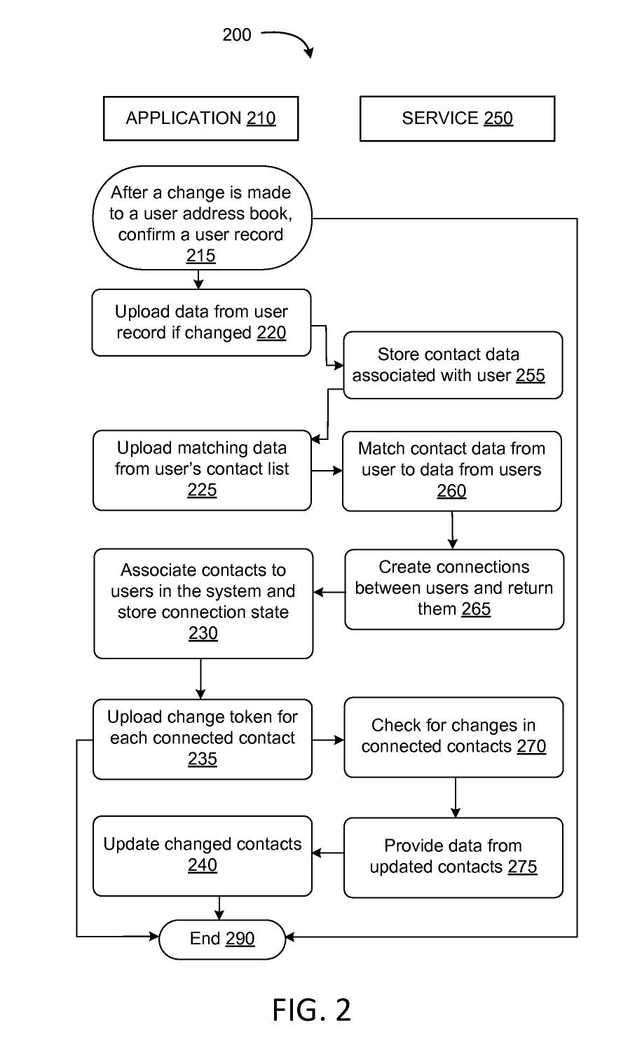

FIG. 2 shows a process flow depicting a flowchart of a first embodiment of a method 200 for contact data sharing. Method 200 illustrates a process flow using an application 210 and a service 250. In one example embodiment the application 210 runs on a mobile device and service 250 runs on a web server in communication with the mobile device. However, other embodiments are not limited in this way and the application 210 and service 250 may run on a single device or distributed over other suitable devices that are capable of running the application or service.

With reference to FIG. 2, in block 215 in response to a change being made to a user address book, the application 210 confirms a user record exists. If a user record does not exist, it may be created.

Once the user record is confirmed, in block 220 data is uploaded from the application in response to a change in data in the record. Then in block 255, service 250 stores contact data associated with the user. In some embodiments, method 200 may create a contact record with at least some authenticated data that represents a user.

Next, in block 225, matching data is uploaded to the service 250 from the users contact list. In this way, service 250 can match contact data from the user to data from other users as shown in block 260. In some embodiments, service 250 uses the contact list that is part of the mobile device, such as an address book, but other embodiments are not limited in this way. The contact list may contain information other than that stored in an address book and the contact list may be stored remotely and be accessed by the service.

When the contact data is matched, service 250 can create connections between users and return the connections to application 210 as shown in block 265. In response to receiving the connection that was created in block 265, in block 230 the application can then associate contacts to users in the system and store a connection state.

In block 235 a change token is uploaded to the service. In other embodiments, the service 250 may manage a change for connected contacts in the application without receiving a change token. In this way, the application 210 is querying the service 250 if the application's data has changed. The service 250 compares the change token or tokens the application 210 has with change tokens stored in a database. If the change tokens are different, the service 250 can send new contact data and/or a new change token to the appplication 210. Additionally, in some embodiments a change token may be sent for an individual connected contact, or some other subset of all connected contacts, for all contacts, etc.

In response to the receiving the change token, in block 270 the service checks for changes in connected contacts and if there is a change, providing the changed data for updated contacts in block 275 to the application 210. In block 240, the application then updates the changed contacts.

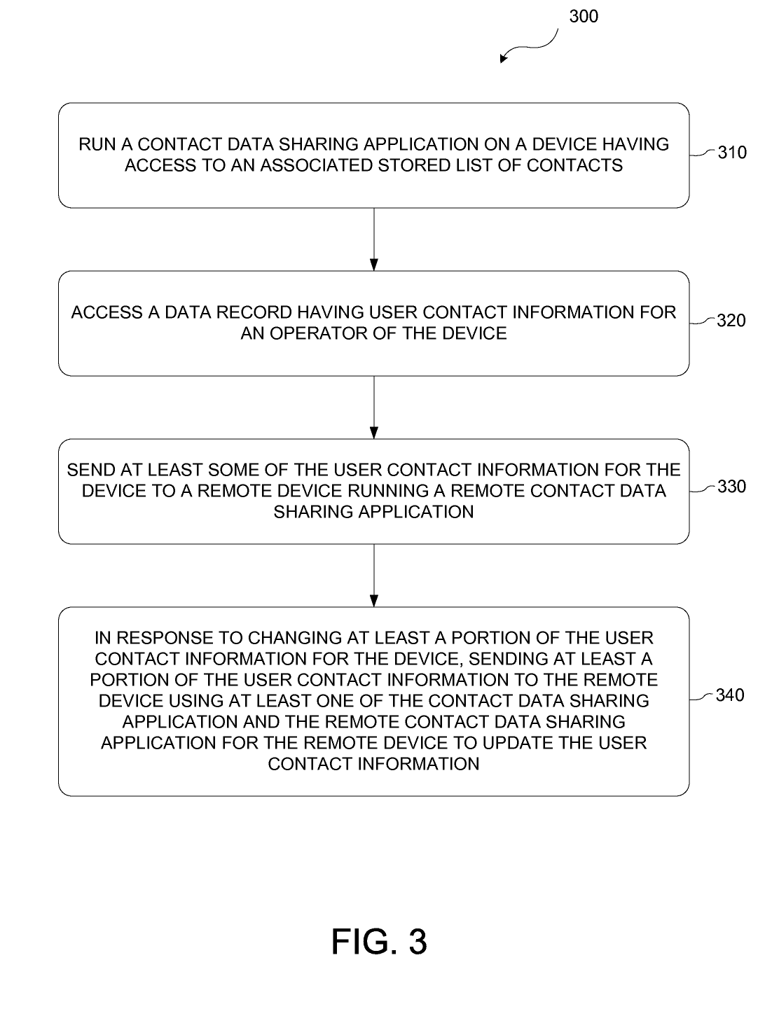

FIG. 3 shows a process flow depicting a flowchart of a second embodiment of a method for contact data sharing 300. Method 300 may be implemented using computing device 110 and/or server 180 as illustrated and described for the embodiment illustrated in FIG. 1, however, method 300 is not limited to the embodiment illustrated in FIG. 1.

In block 310, method for contact data sharing 300 runs a contact data sharing application on a device having a stored list of contacts. In one example, a stored list of contacts may be an address book on a mobile phone, tablet, laptop, or other computing device. Next, in block 320, user contact information is accessed for the device with the contact data sharing application.

Then, in block 330, method 300 sends the user contact information for the device to a remote device running a remote contact data sharing application. In some embodiments, sending the user contact information to the remote device using at least one of the contact data sharing application and the remote contact data sharing application may happen in response to establishing a connection between the contact data sharing application and the remote contact data sharing application. In one example embodiment, the connection may be a connection between a contact list entry and a data record managed by the person referenced in the contact list entry. By way of example, a connection may be a connection between the user of the contact data sharing application and the remote contact data sharing application.

As shown in block 340, in response to changing at least a portion of the user contact information on the device, sending at least a portion of the user contact information to the remote device using at least one of the contact data sharing application and the remote contact data sharing application for the remote device to update the user contact information. In some embodiments, the portion of the user contact information can be the portion of the user contact information that was changed.

It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description.

The subject matter of the present disclosure includes all novel and nonobvious combinations and subcombinations of the various processes, systems and configurations, and other features, functions, acts, and/or properties disclosed herein, as well as any and all equivalents thereof.

1. A contact data sharing method, comprising:
running a contact data sharing application on a device having access to an associated stored list of contacts;
accessing a data record having user contact information for an operator of the device;
sending at least some of the user contact information for the device to a remote device running a remote contact data sharing application; and
in response to changing at least a portion of the user contact information for the device, sending at least a portion of the user contact information to the remote device using at least one of the contact data sharing application and the remote contact data sharing application for the remote device to update the user contact information.

2. The method of claim 1, wherein the at least a portion of the user contact information is the portion of the user contact information that was changed.

3. The method of claim 1, wherein sending the user contact information to the remote device using at least one of the contact data sharing application and the remote contact data sharing application happens in response to establishing a connection between the contact data sharing application and the remote contact data sharing application.

4. The method of claim 3, wherein the connection is a connection between a contact list entry and a data record managed by the person referenced in the contact list entry.

5. The method of claim 3, wherein the list of stored contacts is an electronic address book.

6. The method of claim 3, wherein the remote device is at least one of a mobile phone, a tablet computer, a personal computer or a server.

7. The method of claim 1, further comprising receiving a connection between a contact list entry on a first device and a data record on a second device, wherein the second device is managed by the person referenced in the contact list entry and the connection was remotely established on a server.

8. A system to share contact data, comprising:
a stored list of contacts containing contact information for a plurality of contacts;
a connection module to store connections created between a contact in the list of contacts and data entered on one or more remote devices by the subject of the contact in the list of contacts; and
an update application including a contact management module to confirm a user record is created and to create a connection between a contact in the list of contacts and data entered on a remote device by the subject of the contact in the list of contacts, the update application further including a contact synchronize module to update the contact information in the list of contacts for a change in the contact information resulting from the data entered on a remote device by the subject of the contact in the list of contacts.

9. The system of claim 8, further including a push notification module to receive push notifications, wherein a push notification includes a change to the contact information in a contact in the list of stored contacts.

10. The system of claim 8, wherein the system includes a change token for each contact in the list of stored contacts, wherein the change token is sent to a remote update service to determine if there has been any change in the contact information for the contact, and if there has been any change the system will receive the changed data and store a new change token representing the change.

11. The system of claim 10, wherein the change token includes at least one of the last modified time of a contact in the list of contacts or a checksum string to identify the contact data from a user.

12. The system of claim 8, wherein the system uploads to a remote update service a list of matching property data from each contact record in the stored list of contacts, wherein the contact management module receives from the service a list of contacts that established a connection between a contact in the list of contacts and data entered on a remote device by the subject of the contact in the list of contacts.

13. The system of claim 12, wherein the property data includes at least one of an email address or a phone number for a contact listed in the stored list of contacts.

14. A system to share contact data, comprising:
an update service to manage connections between a stored list of contacts containing contact information for a plurality of contacts stored on at least one remote device;
a contacts data store to store properties of contacts that are uploaded from remote devices; and
a connections data store to store connections created between a contacts in the contacts data store and data entered on one or more remote devices by the subject of the contact in the contacts data store, wherein in response to a change to properties of a contact stored in the contacts data store, the update service sends the change to one or more remote devices connected to the contact in the connections data store.

15. The system of claim 14, further comprising a push notification service to send the change to one or more remote devices connected to the contact in the connections data store.

16. The system of claim 14, wherein the update service receives a change token from a remote device for each contact in a list of stored contacts on the device, wherein the change token is used to determine if there has been any change in the contact information for the contact, and if there has been any change the update service will send the changed data and send a new change token representing the change.

17. The system of claim 14, wherein the change token includes at least one of the last modified time of a contact in the list of contacts or a checksum string to identify contact data from a user.

18. The system of claim 14, wherein the update service receives a list of matching property data from each contact record in the stored list of contacts on a remote device, and establishes a connection between a contact in the list of contacts and data entered on a remote device by the subject of the contact in the list of contacts.

19. The system of claim 18, wherein the property data includes at least one of an email address or a phone number for a contact listed in the stored list of contacts.

20. The system of claim 14, further comprising a verification module to verify a person attempting to change their contact information is the person the contact information refers to.
